(19) United States
(12) Patent Application Publication
(10) Pub. No.: US 2006/0060221 A1
(43) Pub. Date: Mar. 23, 2006

(54) Paint roller and brush cleaning machine

(76) Inventor: Ronald C. Beaver, Coatesville, PA (US)

Correspondence Address: RATNERPRESTIA, P O BOX 980, VALLEY FORGE, PA, 19482-0980, US

(21) Appl. No.: 10/943,414

(22) Filed: Sep. 17, 2004

(51) Int. Cl. B08B 7/00; B08B 3/00; B08B 3/12

(52) U.S. Cl. 134/33; 134/6; 134/184; 134/137

(57) ABSTRACT

A fluid-driven system for cleaning unwanted material from at least one of a brush or roller. The system includes a fluid passage having an inlet for receiving fluid and an outlet for removing fluid from the system. The system also includes a rotator disposed in the fluid passage between the inlet and the outlet. The rotator is driven by the fluid flow and transforms the fluid flow traveling through the fluid passage into rotational movement. The fluid-driven system employs a holder to engage the brush or roller. The holder is connected to and rotated by the rotator such that the brush or roller is caused to rotate about a central axis.

### TECHNICAL FIELD

The present invention relates generally to an apparatus for cleaning tools and, more particularly, to a machine for automatically cleaning paint implements.

### BACKGROUND OF THE INVENTION

Most paint brushes and rollers are intended to be used to apply paint more than one time. That is, they are not manufactured with the intent of being disposable and discarded only after a single use. If properly maintained, especially cleaned, modern paint brushes and paint rollers provide satisfactory results over multiple uses.

The life of a paint brush or roller depends, however, upon the care to which the implement is maintained. Proper maintenance of a paint brush includes cleaning of the paint brush bristles immediately after each use. A paint brush is quickly ruined if paint is left to dry and harden in the paint brush bristles. Although hardened paint can be removed from paint brush bristles, removal usually damages the bristles and thus shortens the life of the paint brush.

To prevent paint from hardening or drying on the paint brush bristles, the paint brush may be wrapped in a material such as plastic saran wrap or aluminum foil, or placed in a sealable plastic bag, such that moisture is retained in the paint. This is a temporary solution. As would be understood by a person of ordinary skill in the art, a paint brush in this condition may only last one or two days before it is ruined. In addition, if the paint brush is needed for application of a paint different from the paint first applied (in, for example, color), the paint brush would nonetheless need to be cleaned.

Paint brushes are offered at a variety of prices. With this range of prices also comes a range of quality. Typically, the quality of a paint brush is reflected in the material of its bristles. Some inexpensive paint brushes have synthetic fiber bristles. Such synthetic fiber bristles include nylon, polyester, and other synthetics for example. Other more expensive paint brushes have natural fiber bristles. Such natural fiber bristles include hair from horse, ox, camel, squirrel, badger, and sable, for example. As can be appreciated, a higher quality paint brush having higher quality bristles is more desirable to the professions I painter and to the do-it-yourself painter.

A high quality paint brush allows a painter more control in the application of paint to a surface. It may allow a painter to paint a well-defined line without the use of painters tape. For example, a quality paint brush may allow a painter to paint in a corner where the wall meets the ceiling. Moreover, a high quality paint brush may allow a painter to edge trim work more easily, particularly when painting crown molding, casing, or baseboard.

Most typically, a professional painter or even an occasional do-it-yourself painter may only have one or two high-quality paint brushes at a time. Given the limited number of brushes, when a painter is painting with more colors then he or she has paint brushes, the painter must take the time to thoroughly clean the paint brush before application of the next color. Although most modern paints are water based, such as latex, there still are paints that are oil based. Depending on the type of paint used, cleaning the paint brush may take significant time (e.g., half an hour or more). It can be appreciated, however, that paint brushes need to be cleaned quickly between colors and thoroughly so as to remove all the paint from the bristles.

Commonly, paint brush bristles have been cleaned by hand in a solution containing the appropriate solvents to dissolve the paint. For latex (water-based) paint, the solvent is water. For oil paints or stains or varnishes, the solvent is a more caustic material such as mineral spirits, petroleum distillates, and turpentine. With the caustic solvents, gloves should be worn to avoid harmful contact with the skin. In addition, these caustic solvents produce noxious and harmful vapors.

Water-based paints are less hazardous to clean then oil-based paints, but still present some problems. For example, for a do-it-yourself painter living in an apartment or condominium without having access to a sink basin or hose, the bathroom or kitchen sink becomes the primary place where paint brushes and paint rollers are cleaned. This is undesirable for many reasons. First, it is undesirable because after the paint brush or roller is cleaned the painter then has to clean the sink itself to remove any residual paint. Second, and most important, it is unsanitary to have paint in places where there are food items or there is a possibility that paint may be ingested. Moreover, while cleaning the paint brushes or rollers in the kitchen sink or bathroom sink, paint may splatter and deposit in areas where it is not desired.

The professional painter encounters similar problems. When a professional painter is at a job and a paint brush or roller needs cleaning, the painter typically must access a truck, van, or other vehicle to clean the paint brush or roller. This assumes that the professional painter also has the ability to carry water or other solvents to clean the brushes or paint rollers at the vehicle.

There remains a need, therefore, for a self-contained paint brush and roller cleaning machine that quickly and efficiently cleans paint brushes and rollers without damaging them. To overcome the shortcomings of existing devices, a new paint brush and roller cleaning machine is provided. An object of the present invention is to quickly and easily clean paint brushes and rollers immediately after use to thereby eliminate the need to wrap the brush or roller and reduce the possibility of damage. A related object is to quickly and easily clean paint brushes and rollers between colors and in a short period of time to minimize loss of productivity.

Another object is to provide a brush and roller cleaning machine that minimizes splashing of the solvent and minimizes exposure time to the vapors. It is still another object of the present invention to provide a paint brush and roller cleaning machine that operates automatically. An additional object is to provide a paint brush and roller cleaning machine that is easily transported.

### SUMMARY OF THE INVENTION

To achieve these and other objects, and in view of its purposes, the present invention provides a fluid-driven system for cleaning unwanted material from at least one of a brush or roller. According to an embodiment of the present invention, the fluid-driven system includes a fluid passage having an inlet for receiving fluid and an outlet for removing fluid from the system. The system also includes a rotator disposed in the fluid passage between the inlet and the outlet. The rotator is driven by the fluid flow and transforms the fluid flow traveling through the fluid passage into rotational movement. The fluid-driven system employs a holder to engage at least one brush or roller. The holder is connected to and rotated by the rotator such that the brush or roller is caused to rotate about a central axis.

According to another embodiment of the present invention, the fluid-driven system for cleaning unwanted material from at least one of a brush or roller includes a container for containing fluid. The container houses the brush or roller and also has a drain switch to drain fluid from the container. The fluid-driven system also includes a fluid passage having an inlet for receiving fluid and an outlet for removing fluid from the system. Within the fluid passage is a valve for diverting fluid between a wash cycle, during which fluid is directed onto the brush or roller, and a dry cycle, during which fluid is not so directed. A rotator is also disposed in the fluid passage between the inlet and outlet and is driven by the fluid. The rotator transforms the fluid flow traveling through the fluid passage into rotational movement. The brush or roller is engaged by a holder, which is connected to and rotated by the rotator. In this manner, the brush or roller is caused to rotate about a central axis.

The present invention is also directed to a method for cleaning unwanted material from a brush or roller in a fluid-driven system. The method includes the steps of passing fluid through a fluid passage having an inlet for receiving fluid and an outlet for removing fluid from the system. A rotator is disposed in the fluid passage between the inlet and the outlet is driven by the fluid such that a brush or roller engaged by a holder, which is connected to the rotator, spins about a central axis. During a wash cycle, fluid is directed through a fluid wand and onto the brush or roller. To initiate a dry cycle, the fluid is diverted from the brush or roller and is caused to flow to the outlet of the system.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of an embodiment of a fluid-driven system of the present invention for cleaning unwanted material from at least one of a brush or a roller;

FIG. 2 is a top view of a rotator according to an embodiment of the present invention; and

FIG. 3 is a perspective view of a fluid-driven system for cleaning unwanted material from at least one of a brush or roller shown in a container according to a further embodiment of the present invention.

### DETAILED DESCRIPTION OF THE INVENTION

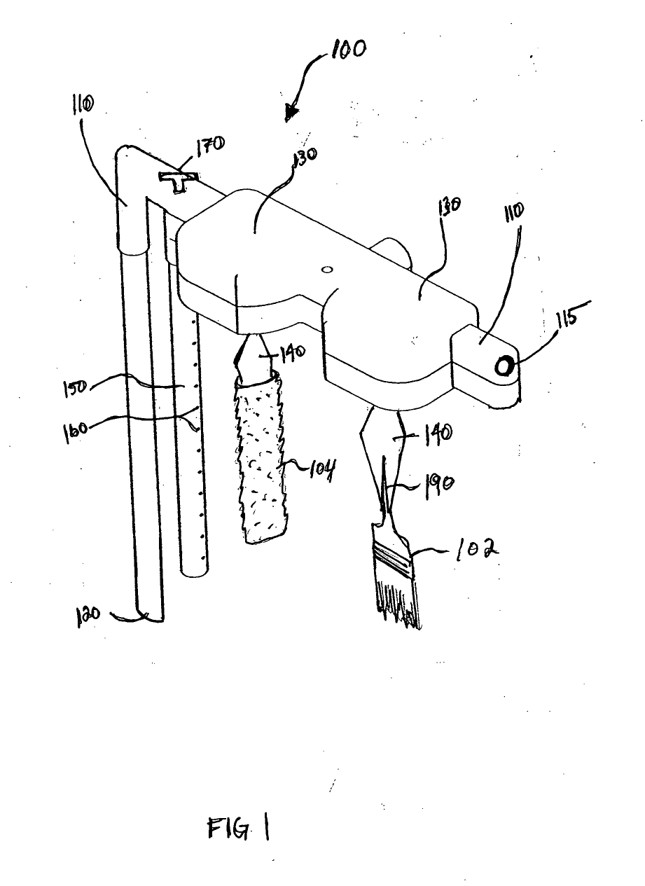

Referring now to the drawing, in which like reference numbers refer to like elements throughout the various figures that comprise the drawing, FIG. 1 shows a fluid-driven system 100 for cleaning unwanted material from at least one of a brush 102 or a roller 104. Depending on the type of material that is on brush 102 or roller 104, an appropriate fluid may be used to drive fluid-driven system 100. For example, if a latex paint (i.e., a water-soluble paint) is on brush 102 or roller 104, an appropriate fluid to drive fluid-driven system 100 could be water. Similarly, if the unwanted material on brush 102 or roller 104 is an oil-based paint or a stain, the appropriate solvent that could be used to drive fluid-driven system 100 and clean brush 102 or roller 104 is an organic petroleum distillate. Exemplary unwanted materials include paint, stain, varnish, lacquer, or dirt. One of ordinary skill in the art would understand which fluid to use in fluid-driven system 100 depending on the type of unwanted material to be removed from brush 102 or roller 104.

Because fluid-driven system 100 is suitable for use with a variety of appropriate solvents, including water-based and organic-based solvents, it is important that system 100 be made from materials that are resistant to those solvents. As would be understood by one skilled in the art, if fluid-driven system 100 uses water as a solvent for cleaning, for example, latex paints, then fluid-driven system 100 may be constructed with a suitable material as would be understood by one skilled in the art. These materials would include, for example, metal, plastic, and rubber. If fluid-driven system 100 uses an organic solvent as the fluid for cleaning, for example, oil-based paints or stains, one skilled in the art would understand which materials would be appropriate to construct fluid-driven system 100. For example, a synthetic rubber may not be used with an organic solvent as the solvent will degrade the rubber. Similarly, if the fluid is mineral spirits, then plastic should not be used to construct fluid-driven system 100. In these circumstances, an appropriate material to construct fluid-driven system 100 would be an inert material substantially resistant to an organic solvent, like stainless steel, aluminum, or other suitable metal.

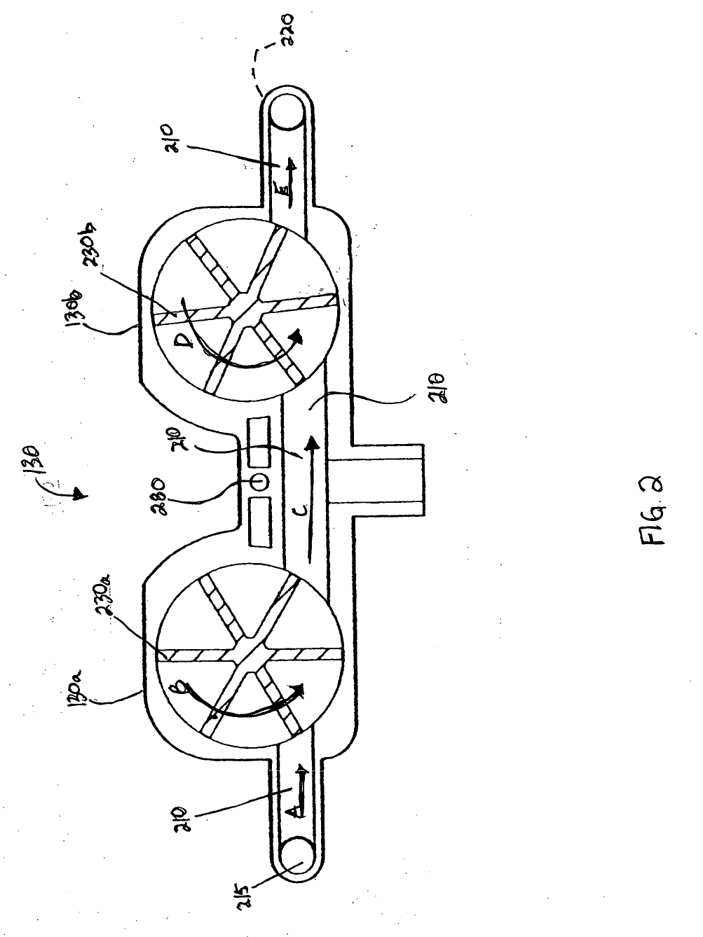

FIG. 1 shows fluid-driven system 100 having a fluid passage 110. Fluid passage 110 has an inlet 115 for receiving fluid into system 100 and an outlet 120 for removing fluid from system 100. Disposed between inlet 115 and outlet 120 is a rotator 130. In the embodiment shown in FIG. 1, two rotators 130 are disposed in fluid passage 110. Rotators 130 transform fluid flow traveling through fluid passage 110 into rotational movement as described in more detail in the description accompanying FIG. 2.

Connected to rotator 130 is a holder 140. In the embodiment shown in FIG. 1, there are two holders 140 connected respectively to each rotator 130. According to this embodiment, two holders 140 and respective rotators 130 are placed about 5 inches from each other. The distance between two holders 140 and respective rotators 130 may be increased or decreased, however, depending on the size of fluid-driven system 100 and rotators 130. Additionally, any number of holders 140 and respective rotators 130 may be incorporated into fluid-driven system 100. The size of fluid-driven system 100 may dictate the number of holders and respective rotators.

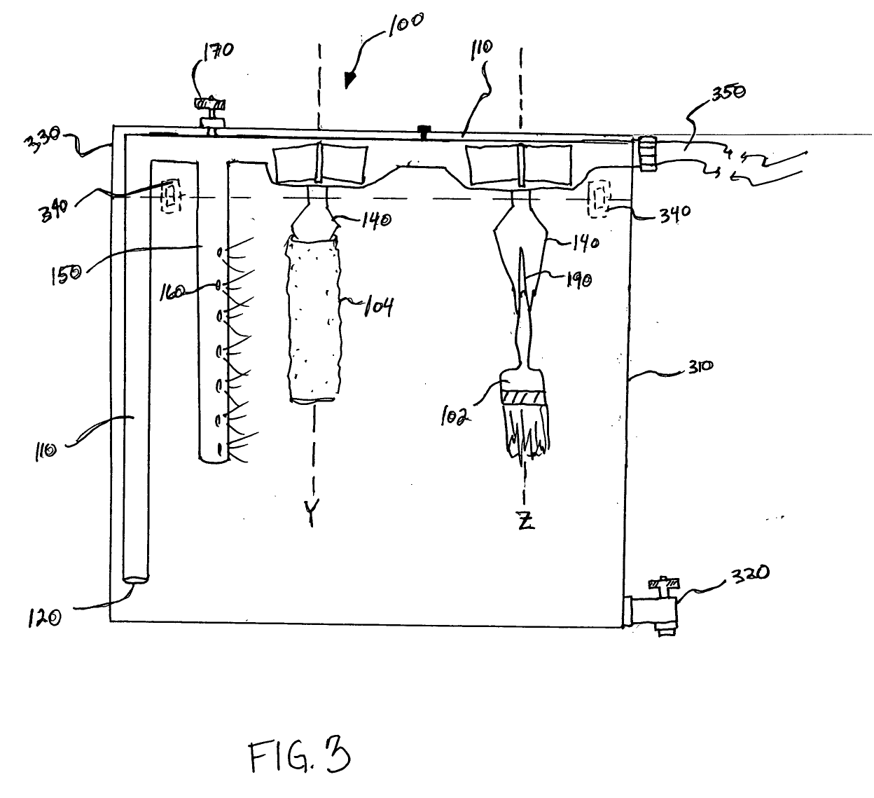

One holder 140 engages a respective brush 102 or roller 104 and is connected to and rotated by rotator 130 such that brush 102 or roller 104 is caused to rotate about a central axis “Y” or “Z” (see FIG. 3). By causing brush 102 or roller 104 to rotate about a central axis, a centrifugal force is created. The centrifugal force causes the unwanted material on brush 102 or roller 104 to be removed, that is, the unwanted material is spun-off brush 102 or roller 104.

According to the embodiment shown in FIG. 1, holder 140 is a truncated cone having a hollow center. Holder 140, through its hollow center, is adapted to receive the handle of paint brush 102. Alternatively, because holder 140 is a truncated cone, roller 104 may be slid over holder 140 and secured on the surface of holder 140. According to this embodiment, holder 140 is constructed of a suitable material such as, for example, a synthetic or natural rubber. Holder 140 engages brush 102 or roller 104 in a frictional fit either through its hollow center or its expanding external surface of the truncated cone. To facilitate holder 140 engaging the handle of brush 102 as shown in FIG. 1, the truncated cone holder 140 optionally has a slit at the narrower end of the cone. This feature allows holder 140 to engage a variety of sizes and shapes of paint brush handles.

FIG. 2 is a cutaway top view of a pair of rotators 130a and 130b comprising rotator 130 shown in FIG. 1. As shown in the embodiment of FIG. 2, fluid passage 210 has a fluid inlet 215 disposed at one end. At the other end of fluid passage 210, is fluid outlet 220 is provided. Disposed within fluid passage 210 are two rotators 130a, 130b. According to the embodiment shown in FIG. 2, rotators 130a, 130b include paddles 230a and 230b. FIG. 2 also shows an attachment mechanism 280 to attach fluid-driven system 100 to a container lid, for example.

FIG. 2 also illustrates how paddles 230a and 230b transform fluid flow passing through fluid passage 210 into rotational movement. FIG. 2 shows rotators 130a and 130b having 6 paddle wheels, although any suitable number of paddle wheels may be used to transform the fluid flow into rotational movement. The embodiment of FIG. 2 illustrates rotators 130a and 130b as a paddle wheel. One skilled in the art would understand that other suitable devices may be used to transform fluid flow into rotational movement.

Fluid entering fluid-driven system 100 passes through fluid inlet 215 and travels through fluid passage 210 in a linear direction shown by arrow A. As fluid enters rotator 130a, the fluid engages paddle 230a causing rotator 130a to rotate in a circular direction shown as line B. Fluid exits rotator 130a, travels through fluid passage 210 in a linear direction shown as arrow C, and engages rotator 130b. As fluid enters rotator 130b, the fluid engages paddle 230b which is caused to rotate in a circular direction shown by arrow D. Then, fluid exits rotator 130b and continues to travel along fluid passage 210 in a linear direction shown by arrow E. The fluid will then exit through outlet 220. Thus, as fluid travels along fluid passage 210 and causes rotators 130a and 130b to rotate, holders 140 attached to rotators 130a, 130b are caused to spin creating a centrifugal force. This centrifugal force acts upon brush 102 or roller 104 to spin-off fluid and unwanted material from brush 102 or roller 104 engaged by holder 140.

FIG. 3 illustrates fluid-driven system 100 according to another embodiment of the present invention. As shown in the embodiment of FIG. 3, fluid-driven system 100 includes a container 310 for retaining fluid and housing brush 102 or roller 104. Container 310 includes a drain 320 to expel the fluid and an outside fluid source 350. FIG. 3 shows a releasably detachable hose as outside fluid source 350. Container 310 also includes a releasably secured lid 330. As shown in the embodiment of FIG. 3, lid 330 is releasably secured to container 310 by way of latches 340. Fluid-driven system 100 may be any suitable size such as a size that would be accommodated by a standard 5-gallon bucket. Fluid-driven system 100 may be a smaller size, however, to fit in a smaller container. According to one exemplary embodiment, the overall size of fluid-driven system has a height of 11.5 inches, a width of 11.5 inches, and a depth of 3 inches.

Referring again to FIG. 1, fluid-driven system 100 may also include a valve 170 disposed in fluid passage 110. In communication with valve 170 is a fluid wand 150. Along the length of fluid wand 150 are a series of apertures 160 through which a stream of fluid is directed onto brush 102 or roller 104. Apertures 160 may be a suitable size to expel fluid, such as between about 0.025-0.15 inches in diameter, 0.05-0.01 inches in diameter, or 0.08 inches in diameter. In this manner, valve 170 in fluid passage 110 diverts fluid between a wash cycle, in which fluid travels through fluid wand 150 and out apertures 160, and a dry cycle, through which the fluid is not so directed, but directed to outlet 120. During the dry cycle, rotator 130 turns holder 140 and, in turn, brush 102 or roller 104, without the application of fluid. Thus, the dry cycle spins fluid off brush 102 or roller 104, thereby drying the implement.

A method of using fluid-driven system 100 for cleaning unwanted material from at least one of brush 102 or roller 104 includes the steps of passing fluid through fluid passage 110 having inlet 115 for receiving fluid and outlet 120 for removing fluid from system 100. As fluid travels through fluid passage 110, the fluid engages rotator 130 connected to holder 140 causing brush 102 or roller 104 to spin about central axis “Y” or “Z.” The step of spinning brush 102 or roller 104 about a central axis imparts a centrifugal force on brush 102 or roller 104, which spins off the unwanted material from brush 102 or roller 104. To engage the wash cycle, valve 170 diverts fluid flow from fluid passage 110 into fluid wand 150. The fluid exits fluid wand 150 through apertures 160 spraying fluid onto brush 102 or roller 104. To initiate the dry cycle, valve 170 is engaged to divert fluid from traveling through fluid wand 150 through to outlet 120 of fluid passage 110.

In this manner, fluid passing through fluid passage 110 continuously engages rotators 130 (regardless of the cycle) causing brush 102 or roller 104 to spin, but does not necessarily enter fluid wand 150. When fluid-driven system 100 is disposed in container 310 as shown in FIG. 3, container 310 may first be filled such that brush 102 or roller 104 is soaked in the fluid. The fluid may then be removed through drain 320. By leaving drain 320 open, during the wash or dry cycles, fluid passes through fluid passage 110 and travels either through fluid wand 150 or outlet 120 and then exits container 310 through drain 320.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A fluid-driven system for cleaning unwanted material from at least one of a brush or roller, the system comprising:
a fluid passage having an inlet receiving fluid for the system and an outlet for removing fluid from the system;
a rotator disposed in the fluid passage between the inlet and outlet and driven by the fluid, the rotator transforming fluid flow traveling through the fluid passage into rotational movement; and
a holder engaging the brush or roller, the holder connected to and rotated by the rotator, wherein the brush or roller is caused to rotate about a central axis.

2. The system of claim 1 wherein the rotator is a paddle.

3. The system of claim 1 wherein the fluid is water.

4. The system of claim 1 wherein the unwanted material is one of paint, stain, varnish, lacquer, or dirt.

5. The system of claim 1 wherein the holder comprises a truncated cone having a hollow center and an external surface, the holder adapted to receive a handle of the brush in its hollow center or to secure the roller on its external surface.

6. The system of claim 5 wherein the holder engages the brush or the roller via a frictional fit.

7. The system of claim 5 wherein the holder is rubber and has a slit at the narrower end of the cone.

8. The system of claim 1 wherein the fluid passage has a valve diverting the fluid between a wash cycle during which fluid is directed onto the at least one brush or roller and a dry cycle during which fluid is not so directed.

9. The system of claim 8 wherein the holder creates a centrifugal force as the holder rotates, the centrifugal force acting upon the brush or roller to spin-off fluid or unwanted material from the brush or roller during either the wash or dry cycles.

10. The system of claim 8 wherein the fluid passage further includes a fluid wand disposed between the inlet and outlet, the valve diverting fluid into the fluid wand during the wash cycle.

11. The system of claim 10 wherein the fluid wand has a series of apertures through which a stream of fluid is directed onto the at least one brush or roller.

12. The system of claim 1 further comprising a container for retaining fluid and housing the at least one brush or roller.

13. The system of claim 12 wherein the container comprises a drain to expel fluid.

14. The system of claim 12 wherein the container has a releasably secured lid.

15. The system of claim 1 wherein at least two rotators are disposed in the fluid passage.

16. The system of claim 15 wherein each of the at least two holders is connected to a respective individual rotator.

17. The system of claim 1 wherein the fluid passage is plastic.

18. A fluid-driven system for cleaning unwanted material from at least one of a brush or roller, the system comprising:
a container for retaining fluid having a drain switch and housing the at least one brush or roller;
a fluid passage having an inlet receiving fluid for the system, an outlet for removing fluid from the system, and a valve diverting the fluid between a wash cycle during which fluid is directed onto the brush or roller and a dry cycle during which fluid is not so directed;
a rotator disposed in the fluid passage between the inlet and outlet and driven by the fluid, the rotator transforming fluid flow traveling through the fluid passage into rotational movement; and
a holder engaging the brush or roller, the holder connected to and rotated by the rotator, wherein the at least one brush or roller is caused to rotate about a central axis.

19. The system of claim 18 wherein the fluid passage further includes a fluid wand disposed between the inlet and outlet, the valve diverting fluid into the fluid wand during the wash cycle.

20. A method of cleaning unwanted material from at least one of a brush or roller in a fluid-driven system, the method comprising the steps of:
passing fluid through a fluid passage having an inlet receiving fluid for the system and an outlet for removing fluid from the system;
spinning a brush or roller about a central axis, the brush or roller engaging a holder connected to and spun by a rotator disposed in the fluid passage between the inlet and outlet and driven by the fluid;
directing the fluid into a fluid wand to initiate a wash cycle during which fluid is directed onto the brush or roller; and
diverting the fluid to flow to the outlet of the fluid passage to initiate a dry cycle during which fluid is not so directed.
